(19) United States
(12) Patent Application Publication
(10) Pub. No.: US 2012/0036094 A1
(43) Pub. Date: Feb. 9, 2012

(54) LEARNING APPARATUS, IDENTIFYING APPARATUS AND METHOD THEREFOR

(75) Inventors: Tomoyuki Takeguchi, Kanagawa (JP); Masahide Nishiura, Tokyo (JP)

(73) Assignee: Kabushiki Kaisha Toshiba, Tokyo (JP)

(21) Appl. No.: 13/254,925

(22) PCT Filed: Dec. 15, 2009
(86) PCT No.: PCT/JP2009/006891

§ 371 Date: Oct. 13, 2011

(30) Foreign Application Priority Data
Mar. 6, 2009 (JP) 2009-053873

(51) Int. Cl. G06F 15/18

(52) U.S. Cl. 706/12

(57) ABSTRACT

A learning apparatus acquires a plurality of training samples containing a plurality of attributes and known classes, gives the plurality of training samples to a route node of a decision tree to be learned as an identifier, generates a plurality of child nodes from a parent node of the decision tree, allocates the training samples whose attribute corresponding to a branch condition for classification is not a deficit values at the parent node of the decision tree out of the plurality of training samples, to any of the plurality of child nodes according to the branch condition, gives the training samples whose attribute is the deficit value, to any one of the plurality of child nodes, and executes the generation of the child nodes and the allocating of the training samples until a termination condition is satisfied.

### TECHNICAL FIELD

The present invention relates to a learning technique of learning a decision tree as an identifier, and an identifying technique using the identifier.

### BACKGROUND ART

There has been hitherto known an identifier learning method using training samples having deficit values, and an identifying method using the identifier.

Patent Document 1 discloses a technique of performing learning of an identifier and identification under the state that a deficit value is complemented. Specifically, according to the Patent Document 1, an originally unnecessary training sample itself is saved after learning of an identifier for deficit value estimation processing, and distance calculation between the training sample and an unknown sample is performed to execute the deficit value estimation processing.

Furthermore, Patent Document 2 and Non-patent Document 1 respectively disclose a technique of performing learning of an identifier and identification without complementing any deficit value. According to the Patent Document 2, a representative case is created from a training sample which is allocated at a learning time in each node of a decision tree, the representative example is saved in each node, and the distance calculation between an unknown sample and the representative case is performed when branch condition determination using a deficit value is performed at the identification time. The non-patent document 1 discloses a method of neglecting a training sample for which a branch condition cannot be estimated and discarding the training sample at the present node, and a method of delivering to each of all child nodes a training sample for which a branch condition cannot be estimated.

### PRIOR ART DOCUMENT

### Patent Document

Patent Document 1: JP-A-2008-234352
Patent Document 2: JP-A-06-96044

### Non-Patent Document

Non-patent document 1: J. R. Quinlan, “Unknown attribute values in induction”, Proceedings of the 6^{th} International Workshop on Machine Learning, 1989

### SUMMARY OF THE INVENTION

### Problem to be solved by the Invention

However, according to the conventional method of complementing the deficit value, complementing precision has an important effect on a final result, and thus it follows great increase of a storage area for complementing processing and a complementing processing cost. Even in the case of a method which does not complement any deficit value, increase of the storage area and increase of the processing cost for identification during which a processing speed is regarded as being important are not avoided.

### Means of solving the Problem

A learning apparatus according to an embodiment of the present invention includes: a training sample acquiring unit configured to acquire a plurality of training samples containing a plurality of attributes and known classes, and give the plurality of training samples to a route node of a decision tree to be learned as an identifier; a generating unit configured to generate a plurality of child nodes from a parent node of the decision tree; a allocating unit configured to allocate the training samples whose attribute corresponding to a branch condition for classification is not a deficit value at the parent node of the decision tree out of the plurality of training samples, to any of the plurality of child nodes according to the branch condition, and give the training samples whose attribute is the deficit value, to any one of the plurality of child nodes; and a termination determining unit configured to execute generation of the child nodes and allocating of the training samples until a termination condition is satisfied.

Furthermore, an identifying apparatus according to an embodiment of the present invention includes: an unknown sample acquiring unit configured to acquire unknown samples containing a plurality of attributes and unknown classes, and give the unknown samples to a route node of a decision tree as an identifier learned by a learning apparatus; a branching unit configured to advance the unknown samples to a leaf node with respect to the decision tree, allocate the unknown samples whose attribute used as a branch condition at a parent node is not a deficit value, to any of a plurality of child nodes according to the branch condition, and advance the unknown samples whose attribute used in the branch condition is the deficit value, to the child node which is given the training data whose attribute is the deficit value when the leaning is executed; and an estimating unit configured to estimate classes of the unknown samples on the basis of a class distribution of the unknown samples reaching the leaf node.

### Advantage of the Invention

Increase of a cost for identification processing and a storage area can be suppressed for even a sample having a deficit value.

### BRIEF DESCRIPTION OF THE DRAWINGS

FIG. 1 is a block diagram showing a learning apparatus according to an embodiment 1 of the present invention.

FIG. 2 is a flowchart showing the operation of the embodiment 1.

FIG. 3 is an explanatory diagram showing allocating of training samples at nodes of the embodiment 1.

FIG. 4 is an explanatory diagram showing a decision tree of the embodiment 1.

FIG. 5 is a block diagram showing a learning apparatus according to an embodiment 2 of the present invention.

FIG. 6 is a flowchart showing the operation of the embodiment 2.

FIG. 7 is a block diagram showing an identifying apparatus according to an embodiment 5 of the present invention.

FIG. 8 is a flowchart showing the identifying apparatus according to the embodiment 5 of the present invention.

FIG. 9 is an explanatory diagram showing a second specific example of the training sample.

FIG. 10 is an explanatory diagram showing a third specific example of the training sample.

### MODE FOR CARRYING OUT THE INVENTION

Terms used in the description of the embodiments of the present invention will be defined before the embodiments are described.

“Sample” contains “class” representing classification and plural “attributes”. For example, in the case of a problem for classifying men and women, the class represents a value for identifying man and woman, and the attributes represent collected values for identifying man and woman such as body height, body weight, percent of body fat, etc.

“Training samples” are samples which are collected to learn an identifier, and the classes thereof are known.

“Unknown samples” are samples whose attributes are acquired, but whose classes are unknown, and the classes of the unknown samples are estimated by using an identifier in identification processing.

“Deficit value” represents that the value of the attribute is unclear.

### Embodiment 1

A learning apparatus 10 according to an embodiment 1 will be described with reference to FIGS. 1 to 4. The learning apparatus 10 of this embodiment learns an identifier based on a decision tree using training samples containing deficit values.

FIG. 1 is a block diagram showing the learning apparatus 10 according to the embodiment.

As shown in FIG. 1, the learning apparatus 10 has a training sample acquiring unit 12, a generating unit 14, a allocating unit 16, a termination determining unit 18, and a storage controlling unit 20, for example. Samples which are affixed with attributes such as body height, body weight, percent of body fat, etc. and classified into man or woman are used as training samples.

A single decision tree is used as an identifier to be learned by the learning apparatus 10. As the identifier may be more suitably used random forests (see random forests; Leo Breiman, “RandomForests”, Machine Learning, vol. 45, pp. 5-32, 2001) or extremely randomized trees (see extremely randomized trees; Pierre Geurts, Damien Ernst and Louis Wehenkel, “Extremely randomized trees”, Machine Learning, vol. 36, number 1, pp. 3-42, 2001, hereinafter referred to as “Pierre Geurts”). These constitute an identifier having plural decision trees obtained by providing a random feature when learning of decision trees is performed. These decision trees have higher identification capability than the identifier based on a single decision tree.

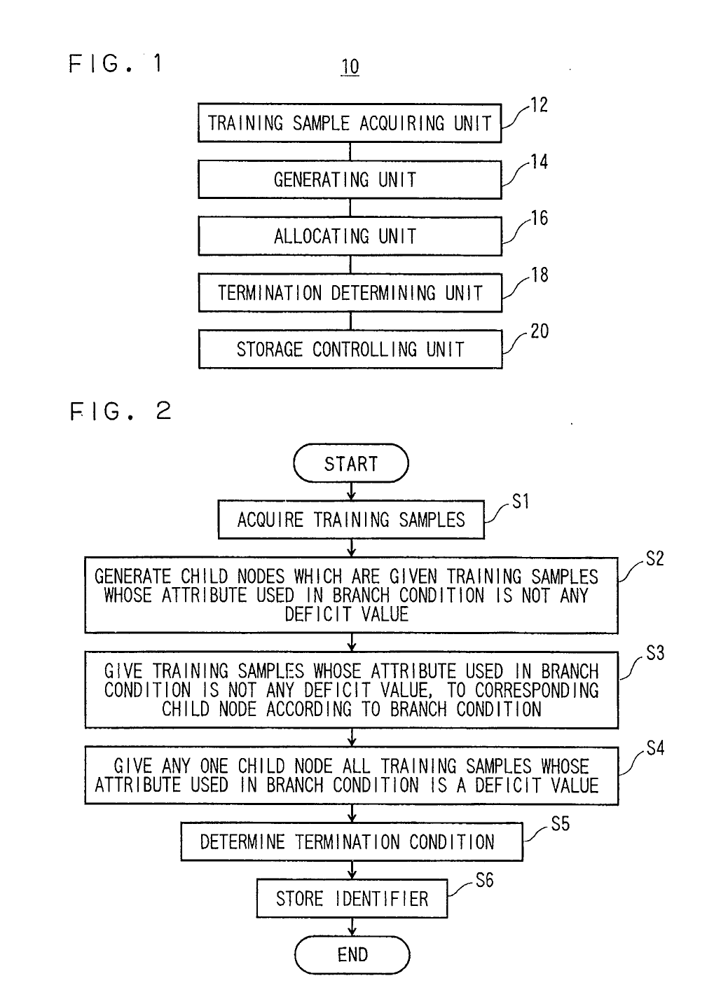

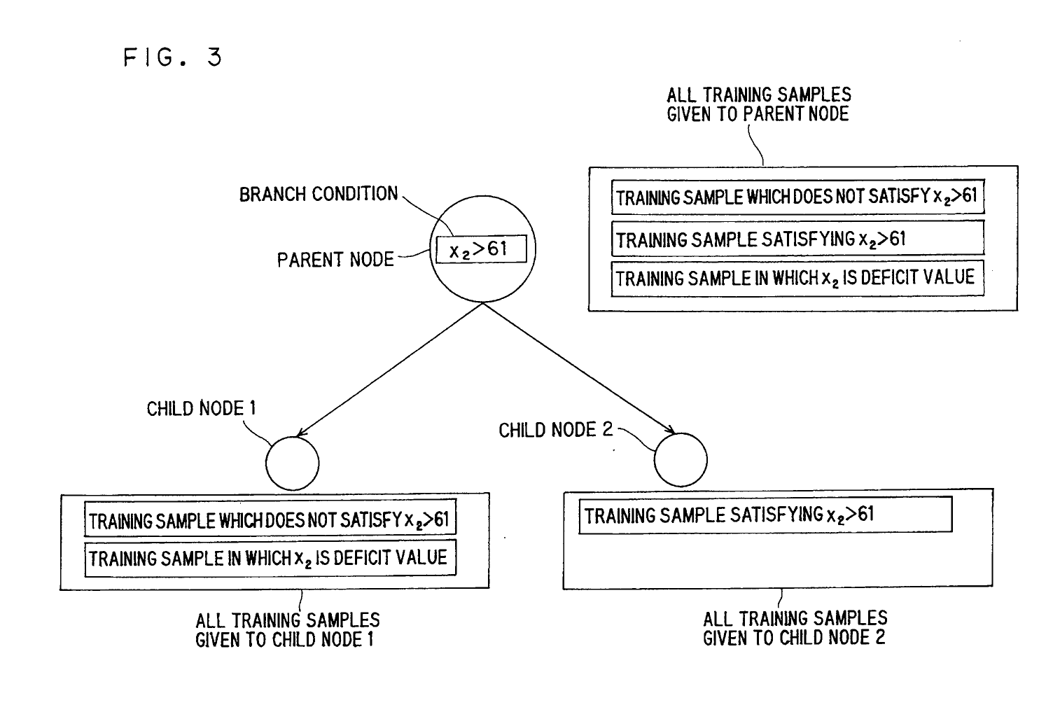

The operation state of the learning apparatus 10 will be described with reference to FIG. 2 and FIG. 3.

FIG. 2 is a flowchart showing an operation of an identifier learning method of the learning apparatus 10.

FIG. 3 is an explanatory diagram showing allocating of training samples at the present node.

In step S1, the training sample acquiring unit 12 acquires plural training samples from the external as shown in FIG. 3, and gives the training samples to route nodes. A branch condition is predetermined in each of nodes other than the route nodes. Each training sample has n attributes of {x₁, x₂, . . . , xₙ}, and the class y thereof is known. Each attribute of each training sample has a continuous value or a discrete value, or has a value representing that it is a deficit value. The training sample may be stored in the training sample acquiring unit 12 in advance.

In step S2, the generating unit 14 generates two child nodes for a parent node containing the route nodes. That is, as shown in FIG. 2, when a branch condition is determined as x₂>61, there would be two choices as to whether the branch condition is satisfied or not satisfied if existence of the deficit value is neglected, and thus the generating unit 14 generates two child nodes. However, actually, training samples given to the parent node are roughly classified into three classes. A first class contains training samples satisfying the branch condition, a second class contains training samples which does not satisfy the branch condition, and a third class contains training samples for which the branch condition cannot be determined because the attribute x₂ used as the branch condition is deficient. Here, the branch condition is a condition for classification. For example, a class separation degree of training samples is used, and an index such as information gain or the like is used as the separation degree. The information gain is information gain described in Pierre Geurts, and it will be referred to as “estimation value” in this specification. The generating unit 14 tries plural branch conditions, and determines a branch condition having the most excellent estimation value as the branch condition, whereby the attribute used as the branch condition is determined.

In step S3, the allocating unit 16 allocates the training samples satisfying the branch condition and the training samples not satisfying the branch condition to the respective corresponding child nodes.

In step S4, training samples for which the branch condition cannot be estimated are given to anyone of the child nodes by the allocating unit 16. The order of the processing of the steps S3 and S4 may be inverted.

In step S5, the termination determining unit 18 repeats this division until the termination condition is recursively satisfied. The following conditions are adopted as the termination condition. A first condition resides in that the number of training samples contained in a node is smaller than a predetermined number. A second condition resides in that the depth of a tree structure is larger than a predetermined value. A third condition resides in that decrease of an index representing goodness of the division is smaller than a predetermined value.

In step S6, a decision tree which is learned as described above and constructed by respective nodes is stored as an identifier into a storing unit by the storage controlling unit 20.

The effect of the learning apparatus 10 described above will be described.

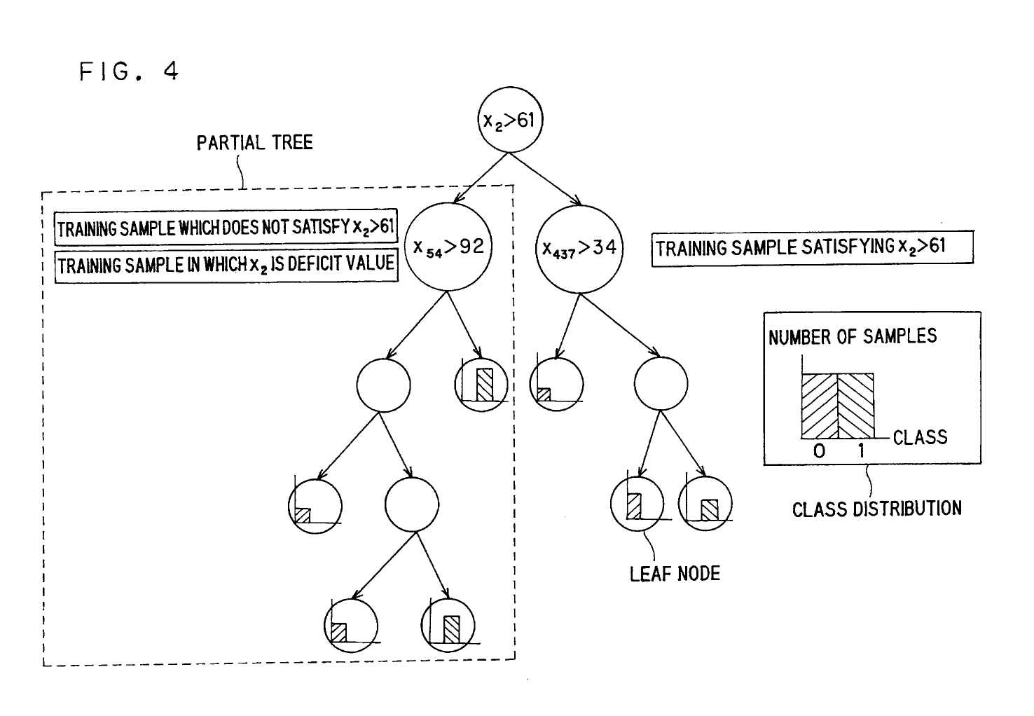

In the learning apparatus 10 of this embodiment, all the training samples which cannot be estimated on the basis of the branch condition are given to one child node. As shown in FIG. 4, after the allocating of the training samples is finished at the parent node, the allocating of the training samples is performed on the basis of different branch conditions at child nodes to which the training samples are given. Therefore, for the training samples which cannot be estimated on the basis of the branch condition at the parent node, the classification method can be learned on the basis of a partial tree subsequent to the child node to which the training samples concerned are given. The partial tree has a smaller frequency of the determination based on the branch condition as compared with the whole decision tree, and thus it is preferable that the number of the kinds of classes to be classified is small. For example, when there is an identification problem of two classes concerning man or women and concerning correct answer or incorrect answer, even a small partial tree may make both the determinations at a leaf node.

Furthermore, in the learning apparatus 10 of this embodiment, it is unnecessary to store information required for identification except for the branch condition as in the case of the method of complementing the deficit value described in the patent document 1, the method of determining on the basis of a representative example described in the patent document 2, etc., and thus a dictionary can be constructed in a storage area which is equivalent to that of the method giving no consideration to the deficit value.

Still furthermore, the non-patent document 1 discloses a method of neglecting training samples for which the branch condition cannot be estimated and discarding the training samples concerned at the present node. However, it is reported in this document that this learning method has bad performance in identification.

The non-patent document 1 also discloses a method of giving all child nodes training samples for which the branch condition cannot be estimated. However, in this learning method, the number of training samples to be given to the child node increases to make a decision tree large as a whole. Therefore, a storage area of decision tree grows, and the identification processing takes much time. According to the learning apparatus 10 of this embodiment, the number of training samples to be given to the child node is not increased, and learning can be performed by using all the training samples. Therefore, the learning taking the deficit value into consideration can be performed while a dictionary is constructed in a storage area which is equivalent to that of the method giving no consideration to the deficit value.

Furthermore, the learning apparatus 10 according to this embodiment is more preferable when a class distribution of training samples whose some attribute is a deficit value is greatly biased. For example, there is considered a case where body weight is set as an attribute in a man/woman identification problem. At this time, assuming that most of training samples whose value of the attribute as the body weight is deficient because no answer is obtained are women's training samples, the deficiency of the attribute itself may become important information for the identification. Therefore, the training samples having these deficit values are bundled together into a group, whereby the precision of the classification can be enhanced.

As described above, according to the learning apparatus 10 of this embodiment, all training samples whose attribute used as a branch condition is a deficit value are given to any one of child nodes which are given training samples whose attribute used as the branch condition is not any deficit value, whereby a decision tree having high identification capability can be learned in the same construction as the decision tree generated according to the learning method giving no consideration to the deficit value.

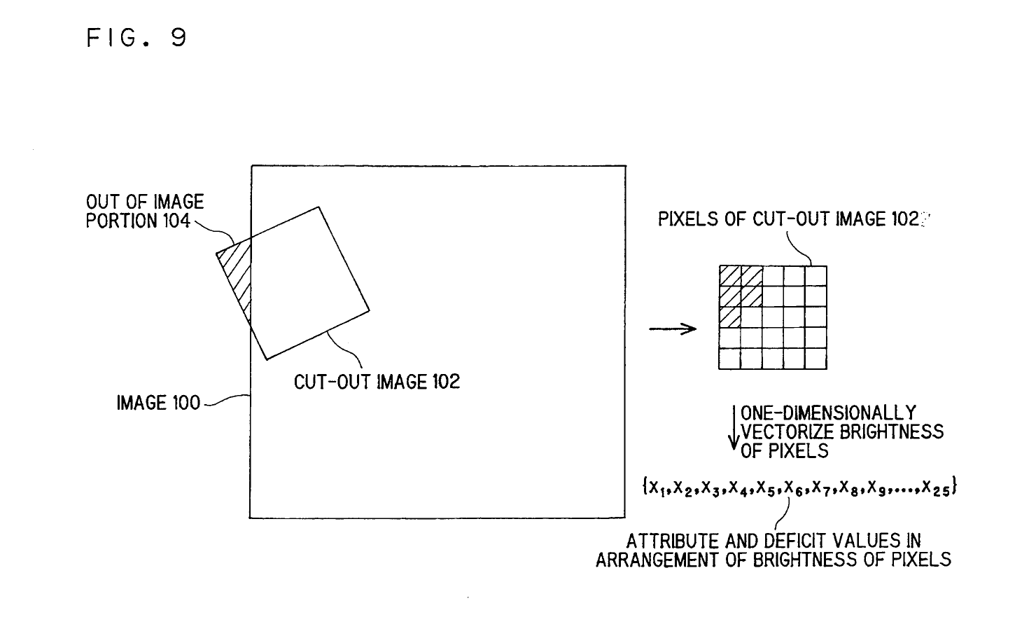

In the above embodiment, samples which are affixed with the attributes such as body height, body weight, percentage of fat, etc. and grouped in accordance with man and woman are used as a first specific example. A second specific example of training samples containing deficit values other than those described above will be described with reference to FIG. 9.

As shown in FIG. 9, in a case where a part of an overall image 100 is cut out, when a cut-out image 102 protrudes to the outside of the image 100, no value can be obtained at an out-of-image portion 104 because no information exists there. Accordingly, the attribute corresponding to the out-of-image portion 104 is set as a deficit value.

A face detection example in which the face of a human being is detected from the image 100 and the position and attitude thereof are estimated will be described hereunder.

In this face detection, a part of the overall image 100 is cut out, and the brightness values of the pixels of the cut-out image 102 or a feature amount [x₁, x₂, . . . , x₂₅] of gradients calculated from the brightness values or the like are arranged on a line to be one-dimensionally vectorized, thereby determining the presence or absence of the face for the cut-out image 102.

The image 102 which is cut out so as to contain the out-of-image portion 104 has an array of attributes containing deficit values, and thus this embodiment is effective when this is learned.

In the face detection as described above, an identifier for collecting samples of face/non-face and classifying the samples into two classes is learned, and the number of attributes increases in accordance with the number of cut-out images. Accordingly, in the first specific example, an additional storage area for handling deficit values of attributes is less, and thus this example is a suitable application example for this embodiment which learns training samples having deficit values at a partial tree.

When the training samples of the first specific example are used, the same image is used for unknown samples described later.

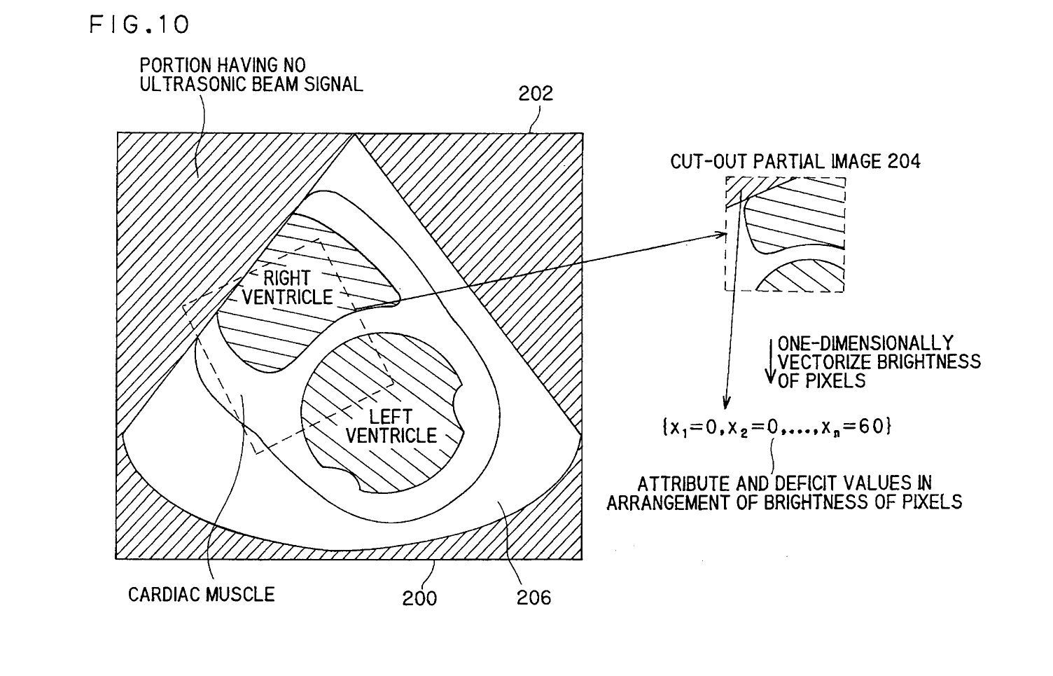

A third specific example of training samples containing deficit values will be described with reference to FIG. 10.

A shown in FIG. 10, the third specific example relates to a case where a part is cut out from an image containing an ineffective area 202 which is a part to an overall image 200. When the ineffective area is contained in a cut-out partial image 204, an attribute obtained from the ineffective part is handled as a deficit value.

An ultrasonic image will be described as an example.

A sectorial portion 206 constructed by ultrasonic beam information and a portion 202 which is not scanned with an ultrasonic beam exist in the whole of the rectangular image 200. A part is cut out from the overall image 200, and the brightness values of the pixels of the cut-out image 204 or a feature amount [x₁, x₂, . . . , xₙ] calculated from the brightness values are arranged on a line to be set as a one-dimensionally vectorized attribute. This is an array of attributes containing deficit values, and thus this embodiment is effective to learn this image.

The image 200 is not limited to a two-dimensional image, and a three-dimensional image may be handled. In a medical field, three-dimensional volume data are obtained in modality such as CT, MRI, an ultrasonic image, etc. With respect to a position/attitude estimating problem of a specific site or an object (for example, a problem of setting a left ventricle center as a center and specifying an apex-of-heart direction and a right ventricle direction), a sample which is cut out at right position/attitude is set as a correct answer sample while a sample which is cut out at wrong position/attitude is set as a wrong sample, and learning of two classes is performed. When cut-out is three-dimensionally performed, the number of attributes is larger as compared with the two-dimensional image. Accordingly, in the second specific example, an additional storage area for handling the deficit values of the attributes is less, and thus this is an application example suitable for this embodiment in which training samples having deficit values at a partial tree are learned.

When training samples of the second specific example are used, the same image is used for unknown samples described later.

### Embodiment 2

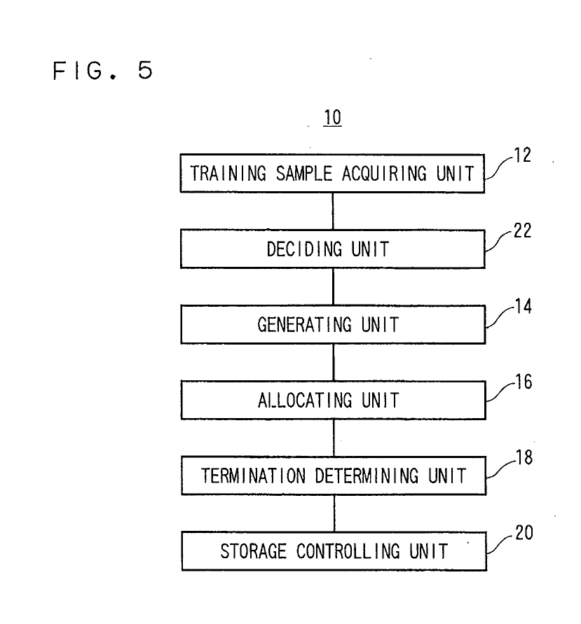

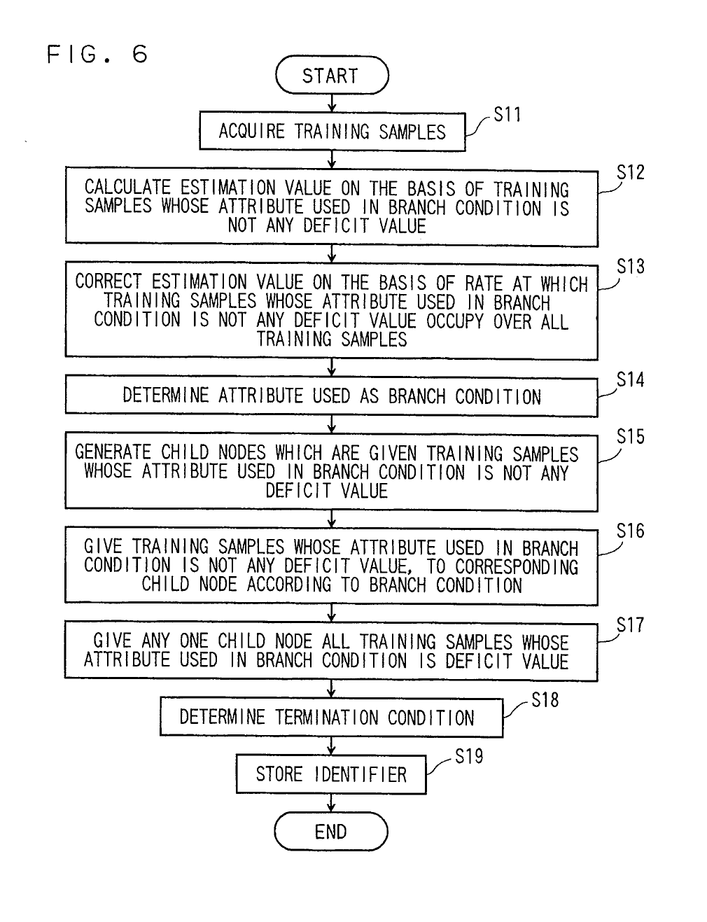

A learning apparatus 10 according to an embodiment 2 will be described with reference to FIG. 5 and FIG. 6.

The learning apparatus 10 of this embodiment allocates training samples having deficit values described with reference to the embodiment 1, and additionally corrects the branch condition by using training samples having deficit values.

FIG. 5 is a block diagram showing the learning apparatus 10 according to the embodiment 2.

As shown in FIG. 5, the learning apparatus 10 has a deciding unit 22 in addition to the training sample acquiring unit 12, the generating unit 14, the allocating unit 16, the termination determining unit 18 and the storage controlling unit 20 of the embodiment 1.

The operation state of the learning apparatus 10 will be described with reference to FIG. 6. FIG. 6 is a flowchart showing the operation of the learning apparatus 10 according to this embodiment.

In step S11, the training sample acquiring unit 12 acquires plural training samples, and gives them to a route node.

In step S12, the deciding unit 22 estimates a branch condition settled by setting a threshold value to an appropriate attribute. The training samples whose attributes are deficit values are excluded, and the estimation value in the embodiment 1 is used as a class separation degree of training samples on the basis of a branch condition set by using the remaining training samples. Here, it is better for the branch condition to be set that the training samples can be separated every class and the number of training samples whose attribute used as the branch condition is a deficit value is small. The reason for this resides in that the overall decision tree can be made compact when a branch condition which can correctly classify a larger number of training samples is selected, and thus reduction of the storage area and reduction of identification processing can be achieved.

In step S13, the deciding unit 22 corrects the branch condition so that the estimation value is increased as an occupation rate at which the training samples whose attribute used in the branch condition is not any deficit value occupies in all the training samples allocated to the parent node is higher. Specifically, there is considered a method of weighting the estimation value at the above rate or the like. When the estimation value is represented by H, the number of training samples whose attributes are not deficit values is represented by a and the number of training samples whose attributes are deficit values is represented by b, it is assumed that the corrected estimation value H′=a/(a+b)*H.

In step S14, the deciding unit 22 tries plural branch conditions, and decides as the branch condition one of these branch conditions which provides the best corrected estimation value H′ among these branch conditions, whereby the attribute used as the branch condition is determined.

In step S15, two child nodes to be given training samples whose attributes are not deficit values are created on the basis of the branch condition decided by the deciding unit 22 for parent nodes containing the route node by the generating unit 14.

In step S16, the training samples whose attributes are not deficit values are allocated to the child nodes on the basis of the branch condition by the allocating unit 16.

In step S17, training samples whose attribute used in the branch condition is a deficit value are given to any one child node. The processing order of the steps S16 and S17 may be inverted.

In step S18, the termination determining unit 18 repeats this division until the termination condition is recursively satisfied. The termination condition is the same as in step S5 in the embodiment 1.

In step S19, the storage controlling unit 20 stores each node of the decision tree learned as described above as an identifier into a storage unit.

The effect of the learning apparatus 10 according to this embodiment will be described.

By selecting attributes which enables the number of training samples having deficit value to be as less as possible and also are excellent in class separation degree in selecting the branch condition, the whole of the decision tree can be made small, and thus it is possible to reduce the storage area and reduce the identification processing.

Furthermore, the selection of the attributes which reduces the number of training samples having deficit values means that the number of training samples whose attributes used in the branch condition have deficit values is reduced. Here, when a method of allocating to a specific node training samples for which the branch condition described in the non-patent document 1 cannot be estimated is adopted, in the specific node, it is required to form a subsequent partial tree by only a small number of allocated training samples, and thus leaning is liable to be unstable. Therefore, identification capability to unknown samples having deficit values for the same attribute is lost. However, in the learning apparatus 10 of this embodiment, even when the number of training samples whose attributes used in the branch condition have deficit values are small, the subsequent learning can be progressed in combination with the training samples whose attributes are not deficit values, and thus the learning is stabilized.

As described above, according to the learning apparatus 10 of this embodiment, the class separation is excellent, and the decision tree can be effectively learned by selecting the branch condition using the attribute which reduces the number of samples having deficit values.

Furthermore, according to the learning apparatus 10 of this embodiment, the number of training samples whose attribute used in the branch condition has a deficit value is reduced, and also the leaning in the child nodes is progressed in combination with training samples whose attribute used as the branch condition is not any deficit value, whereby instability of the learning which is caused by the number of training samples being small can be avoided.

### Embodiment 3

A learning apparatus 10 according to an embodiment 3 will be described.

According to the learning apparatus 10 according to this embodiment, it is stored in the value of the attribute by the training sample acquiring unit 12 that the attribute of the training sample is a deficit value.

In a case where the codomain of values which are not deficit values is known in the attribute, the processing of the step S3 and the processing of the step S4 in the embodiment 1 can be simultaneously performed when values smaller than the codomain are set as deficit values.

For example, in a case where it is known that an attribute x has any value from 0 to 100, when x has a minus value, it is defined as a deficit value. Accordingly, when a branch condition is set to x>50, a training sample in which x is a deficit value is given to the same child node to which a training sample satisfying x>50 is given. When values smaller than the codomain are set as deficit values for all attributes, a training sample whose attribute used in a branch condition is a deficit value is necessarily given to a child node in a predetermined direction.

According to this embodiment, the decision tree considering deficit values can be learned without adding any storage area for considering the deficit values.

The above effect can be obtained even when deficit values larger than the codomain of the attribute are defined as deficit values.

### Embodiment 4

A learning apparatus 10 according to an embodiment 4 will be described.

According to the learning apparatus 10 of this embodiment, in the allocating unit 16, a child node receiving training samples whose attribute used in the branch condition is a deficit value is stored in the parent node. By storing this information, the direction of the child node to which the training samples as deficit values are given can be controlled every node.

The thus-obtained effect is as follows.

When the allocating unit 16 gives training samples having deficit values to a child node to which a smaller number of training samples are given, it can be prevented that only a specific branch grows, and thus a well-balanced decision tree can be learned.

Furthermore, the allocating unit 16 compares the class distribution of the training samples given to the child nodes with the class distribution of the training samples having the deficit values, and when the training samples having the deficit values are given to a child node having a closer class distribution, subsequent branch growth can be suppressed.

Still furthermore, the direction of the child node which are given training samples having deficit values in each node can be stored on the basis of only one value, and thus the decision tree paying attention to the training samples having the deficit values can be learned with a little increase of the storage area.

### Embodiment 5

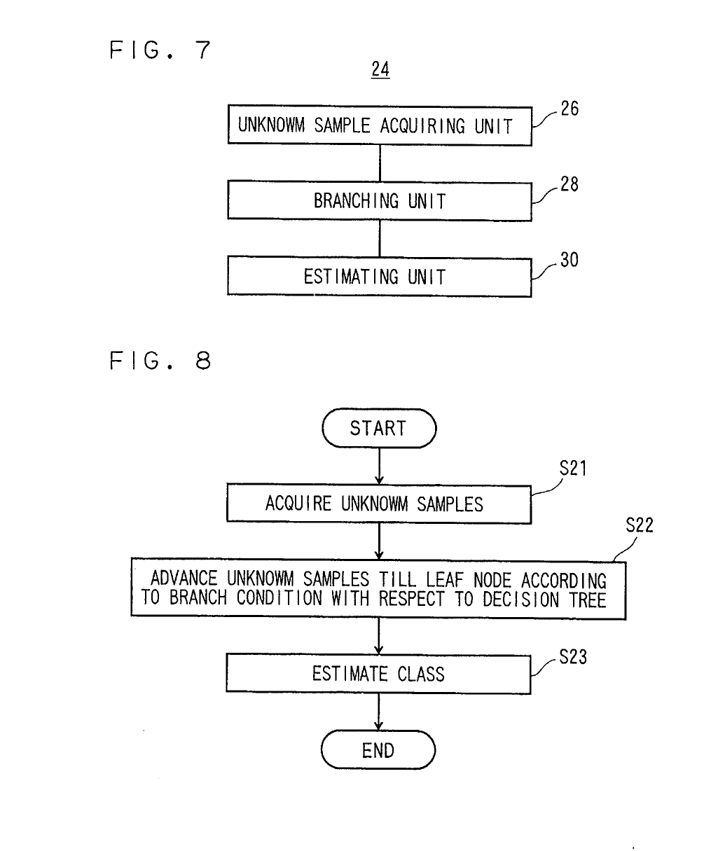

In an embodiment 5, an identifying apparatus 24 using the identifier learned by the learning apparatus 10 of the embodiment 1 will be described with reference to FIG. 7 and FIG. 8.

FIG. 7 is a block diagram showing the identifying apparatus 24 of this embodiment.

The identifying apparatus 24 has an unknown sample acquiring unit 26, a branching unit 28 and an estimating unit 30.

The operation of the identifying apparatus 24 will be described with reference to the flowchart of FIG. 8.

In step S21, the unknown sample acquiring unit 26 acquires from the external unknown samples on which class estimation is required to be executed, and gives the route node of the decision tree as the identifier learned by the learning apparatus 10 of the embodiment 1.

In step S22, the branching unit 28 successively advances unknown samples from the route node to the leaf node in the decision tree according to the branch condition. That is, unknown samples whose attribute used in the branch condition in parent node is not any deficit value are allocated to any of plural child nodes according to the branch condition. Furthermore, when the attribute used in the branch condition in the parent node is a deficit value in the unknown samples, the unknown samples are advanced for a child node which is given training data in which this attribute is a deficit value at the learning time of the learning apparatus 10 of the embodiment 1.

In step S23, the estimating unit 30 estimates the classes of the unknown samples on the basis of the class distribution of the unknown samples reaching the leaf node of the decision tree.

Accordingly, in the case of the identifying apparatus 24 of this embodiment, the unknown samples are advanced in the same advancing direction as the training samples whose attribute identical to the attribute is a deficit value under the learning of the learning apparatus 10, and thus the class estimation can be performed with high precision.

When the identifier learned by the learning apparatus 10 of the embodiment 2 is used, the same identifying apparatus 24 as described above is used, whereby the class estimation of the unknown samples can be performed.

### Embodiment 6

In an embodiment 6, an identifying apparatus 24 using the identifier learned by the learning apparatus 10 of the embodiment 3 will be described.

When the learning is executed by the learning apparatus 10 of the embodiment 3, the branching unit 28 of the identifying apparatus 24 also inputs values out of the codomain of the attribute into the deficit values of the unknown samples to execute the processing as in the case of the learning time. Accordingly, when the allocating is executed on the basis of the branch condition based on the deficit value, the unknown samples can be automatically advanced in the same advancing direction as the training samples having the deficit values.

### Embodiment 7

In an embodiment 7, a learning apparatus 24 using the identifier learned by the learning apparatus 10 of the embodiment 4 will be described.

When the learning is executed by the learning apparatus 10 of the embodiment 4, the branching unit 28 can advance the unknown samples in the direction of the specified child node when the allocating is executed on the basis of the branch condition based on the deficit value.

### Embodiment 8

A learning apparatus 10 and an identifying apparatus 24 of an embodiment 8 will be described.

In the allocating unit 16 of the learning apparatus 10 according to this embodiment, deficit value presence/absence information representing that there is no training sample whose attribute used in the branch condition is a deficit value is stored in the parent node under the learning of the decision tree.

The thus-obtained effect is as follows.

When the class estimation of the unknown samples is executed, the direction of a child node to which an unknown sample is advanced is determined on the basis of the branch condition of each parent node. When the attribute used in the branch condition is a deficit value in the unknown sample, the unknown sample should be advanced to a child node which is given a training sample in which this attribute is a deficit value. However, when the deficit value presence/absence information representing that there is no training sample having a deficit value under learning exists in this parent node, there is a high probability that the allocating of the branch condition of the unknown samples is not correctly executed at that parent node.

Therefore, in the identifying apparatus 24 of this embodiment, the next processing is added when the attribute used in the branch condition at the parent node is a deficit value in the unknown sample and also it is known from the deficit value presence/absence information that there is no training sample having the deficit value at that node.

For example, as this additional processing, the unknown samples are advanced to all the child nodes, and the class distributions of all the leaf nodes to which the unknown samples reach are integrated with one another to estimate the classes of the unknown samples. The unknown sample does not have any index for indicating which child node the unknown sample should be advanced to. Therefore, the advancement to all the child nodes enables the identification processing to be executed by using all partial trees subsequent thereto, thereby contributing enhancement of the identification precision. Furthermore, it can be informed that the label estimation of the unknown samples cannot be well executed with high probability.

### Modification

The present invention is not limited to the above embodiments, and the constituent elements may be modified and converted into tangible forms without departing from the subject matter of the present invention at the implementing stage. Furthermore, plural constituent elements disclosed in the above embodiments may be properly combined, whereby various inventions can be formed. For example, some constituent elements may be deleted from all the constituent elements disclosed in the above embodiments. Furthermore, the constituent elements over different embodiments may be properly combined.

For example, in the generating unit 14 of the learning apparatus according to each of the above embodiments, two child nodes are generated for one parent node. However, the present invention is not limited to this style, and three or more child nodes may be generated.

Furthermore, the learning apparatus 10 and the identifying apparatus 24 can be implemented by using a general-purpose computer as a base hardware, for example. That is, the construction of each part of the learning apparatus 10 and the identifying apparatus 24 can be implemented by making a processor mounted in the above computer execute a program. At this time, the function of each part of the learning apparatus 10 and the identifying apparatus 24 may be implemented by pre-installing the above program into a computer or by storing the above program into a storage medium such as CD-ROM or the like or distributing the above program through a network to arbitrarily install this program into the computer.

### DESCRIPTION OF REFERENCE NUMERALS

10 . . . learning apparatus, 12 . . . training sample acquiring unit, 14 . . . generating unit, 16 . . . allocating unit, 18 . . . termination determining unit, 20 . . . storage controlling unit, 22 . . . deciding unit, 24 . . . identifying apparatus, 26 . . . unknown sample acquiring unit, 28 . . . branching unit, 30 . . . estimating unit

1. An identifying apparatus using a decision tree that has been learned as an identifier by training samples, each of which has a plurality of attributes and a known class, comprising:
an unknown sample acquiring unit configured to acquire unknown samples, each of which has a plurality of attributes and an unknown class, and to provide the unknown samples to a root node of the decision tree;
a branching unit configured to forward the unknown sample to a leaf node in the decision tree, by allocating the unknown sample whose attribute being used at parent node as a branching condition is not of deficit value, to any among a plurality of child nodes in accordance with the branching condition, and by forwarding the unknown sample whose attribute being used at the parent node as the branch condition is of deficit value, to one(s) among the plurality of child nodes, which has been predetermined for each of the parent nodes; and
an estimating unit configured to estimate classes of the unknown samples, based on distribution of the classes of the unknown samples having reached the leaf nodes.

2. An identifying apparatus according to claim 1, wherein the branching unit is further configured to store at the parent node, information on absence of the deficit value, which indicates that the training sample whose attribute being used at the parent node as the branching condition is of deficit value has not been handled in respect of the parent node.

3. An identifying apparatus according to claim 2, wherein the branching unit is further configured to forward the unknown sample whose attribute being used at the parent node as the branch condition is of deficit value, from the parent node storing the information on absence of the deficit value to each of the child nodes.

4. An identifying apparatus according to claim 2, wherein the branching unit is further configured to inform low precision of estimating the class of the unknown sample whose attribute being used at the parent node as the branch condition is of deficit value if the parent node stores the information on absence of the deficit value.

5. A learning apparatus comprising:
a training sample acquiring unit configured to acquire a plurality of training samples, each of which has a plurality of attributes and an unknown class, and to provide the training samples to a root node of a decision tree that is to be used in the identifying apparatus according to claim 1;
a generating unit configured to generate a plurality of child nodes from a parent node in the decision tree;
an allocating unit configured to allocate the training sample whose attribute being used at the parent node in the decision tree as a branching condition is not of deficit value, among said plurality of training samples, to any among said plurality of child nodes in accordance with the branching condition, and to forward the training sample whose attribute being used at the parent node as the branch condition is of deficit value, to one among the plurality of child nodes and to store a fact to which one among the plurality of child nodes the training sample is forwarded; and
a termination determining unit configured to make execution or repeating of generating of the child nodes and allocating of the training samples until a termination condition is met.

6. A learning apparatus according to claim 5, further comprising:
a deciding unit configured to calculate an estimation value for the branching condition, based on the training sample whose attribute being used at the parent node in the decision tree as a branching condition is not of deficit value, and to correct the estimation value in a manner that the estimation value is increased with increase of a ratio of said training sample whose attribute being used at the parent node in the decision tree as a branching condition is not of deficit value, to whole of the training samples, so as to determine the branching condition.

7. (canceled)

8. An identifying method using a decision tree that has been learned as an identifier by training samples, each of which has a plurality of attributes and a known class, comprising:
acquiring unknown samples, each of which has a plurality of attributes and an unknown class, and providing the unknown samples to a root node of the decision tree;
forwarding the unknown sample to a leaf node in the decision tree, by allocating the unknown sample whose attribute being used at parent node as a branching condition is not of deficit value, to any among a plurality of child nodes in accordance with the branching condition, and by forwarding the unknown sample whose attribute being used at the parent node as the branch condition is of deficit value, to one(s) among the plurality of child nodes, which has been predetermined for each of the parent nodes; and
estimating classes of the unknown samples, based on distribution of the classes of the unknown samples having reached the leaf nodes.
